(19) United States
(12) Patent Application Publication
(10) Pub. No.: US 2019/0211230 A1
(43) Pub. Date: Jul. 11, 2019

(54) FABRIC ADHESIVE TAPE

(71) Applicant: TESA SE, Norderstedt (DE)

(72) Inventor: Patrick KEREP, Hamburgh (DE)

(73) Assignee: TESA SE, Norderstedt (DE)

(21) Appl. No.: 16/316,144

(22) PCT Filed: Jul. 4, 2017
(86) PCT No.: PCT/EP2017/000790

§ 371 Date: Jan. 8, 2019

(30) Foreign Application Priority Data
Jul. 8, 2016 (DE) 102016212483.8

(51) Int. Cl. C09J 7/21; C09J 7/38; C09J 5/00; D03D 1/00; D03D 15/00; D03D 13/00

(52) U.S. Cl. CPC C09J 7/21; C09J 7/385; C09J 5/00; D03D 1/00; D03D 15/0094; D10B 2331/04; C09J 2400/263; C09J 2467/006; C09J 2433/00; C09J 2203/302; D03D 13/008

(57) ABSTRACT

Adhesive tape consisting of an adhesive layer on at least one side of a carrier, wherein the carrier is a woven fabric, preferably a woven polyester fabric, characterized in that
the fabric has the following construction:
   the thread count in the warp is 34 to 54/cm
   the thread count in the weft is 15 to 30/cm
   the warp threads have a yarn weight between 38 and 55 dtex
   the weft threads have a yarn weight between 500 and 750 dtex.

The invention relates to a tape, preferably for sheathing of elongate items such as especially lines or cable assemblies, formed of a carrier supporting preferably on one side at least a pressure-sensitive type of adhesive coating. The invention further relates to the use of the tape and also to a cable harness jacketed with the tape of the invention.

There are many industries where bundles of a multiplicity of electrical lines are wrapped either before installation, or when already mounted, in order to reduce the space requirements of the bundle of lines by bandaging, and also to obtain protective functions. Film-backed adhesive tapes provide a certain degree of protection against ingress of liquid; lofty and bulky adhesive tapes based on thick nonwovens or foams as carriers provide damping properties; and abrasion-resistant, stable carrier materials provide protection against scuffing and rubbing.

Adhesive tapes for cable jacketing are tested and classified in the automotive industry according to extensive sets of standards such as, for example, LV 312-1 “Protective Systems for Wire Harnesses in Motor Vehicles, Adhesive Tapes; Test Guideline” (10/2009) as jointly operated by Daimler, Audi, B M W and Volkswagen, or the Ford specification ES-XU5T-1A303-aa (Revision 09/2009) “Harness Tape Performance Specification”. Hereinafter the designations of these standards are shortened to LV 312 and the Ford specification respectively.

The scuff resistance of adhesive tapes is measured in terms of their abrasion resistance.

The international standard ISO 6722, chapter 9.3 “Scrape abrasion test” (issue April 2002), has become established as the method to determine the abrasion resistance of protective systems in vehicular electrics. It is in line with the ISO 6722 standard that the abrasion resistance of adhesive tapes is tested under LV 312. The test specimen, having a length of about 10 cm, is adhered in a single ply onto a 5 or 10 mm thick steel mandrel in the longitudinal direction. The abradant used is a steel wire 0.45 mm in diameter, which rubs across the test specimen centrally under a weight loading of 7 N. The number of double strokes to destroy the test specimen is determined as the metric for the abrasion properties. In the case of a woven fabric, the direction of movement of the steel wire is aligned parallel to the warp threads.

The result of the test is reported in terms of the abrasion class of the test specimen by reporting the mandrel diameter and the weight loading. Adhesive tapes are classified in classes A to F as shown in Table 1.

A mandrel diameter of 5 mm will usually destroy the test specimen in fewer strokes than a mandrel diameter of 10 mm. An adhesive tape is therefore able for example to attain abrasion class D at 10 mm and abrasion class C at 5 mm.

TABLE 1
LV 312 division of abrasion classes

| Abrasion class | Requirement | |
|---|---|---|
| A no abrasion control | <100 | strokes |
| B low abrasion control | 100-499 | strokes |
| C middling abrasion control | 500-999 | strokes |
| D high abrasion control | 1000-4999 | strokes |
| E very high abrasion control | 5000-14 999 | strokes |
| F extremely high abrasion control | ≥15 000 | strokes |

Adhesion tapes of abrasion class D are thus highly abrasion-resistant adhesive tapes.

High abrasion control these days utilizes mostly single-ply woven-fabric adhesive tapes consisting of a woven-fabric carrier (a woven polyester fabric, for example) and a layer of adhesive.

The woven carrier fabrics are characterized by the thread material (polyester yarn for example), the thread weight of the threads (weight per length, the unit being dtex, 1 dtex=1 g/10 000 m of thread) and the thread density or thread count (number of threads per cm). Woven fabrics consist of warp threads (longitudinal direction, machine direction, also corresponds to the longitudinal direction of the adhesive tape produced therefrom) and weft threads (transverse threads).

The threads are typically interwoven in a plain weave. Other types of weave are satin/sateen, of which there are regular and irregular forms, and twill. A twill weave, an example being a “2 over 1 twill”, will produce a twill line on the fabric, extending diagonally to the machine direction. Twill-woven fabrics are generally somewhat softer than plain-woven fabrics. Flexural stiffness is lower in the diagonal direction in particular. This may be an advantage for adhesive tapes produced therefrom.

The woven fabrics may have been subsequently dyed or consist of spun-dyed yarns.

The threads may consist of spun yarns or filament yarns (continuous yarns). Filament yarn is typically used. It consists of a fixed number of individual filaments and may be in textured or flat and point-bonded or unbonded form.

Yarns are produced using fibres.

Two forms of fibres are distinguished.

Cut fibres (the term “staple fibres” is used interchangeably) have a finite length. Continuous fibres, also called filaments, have a virtually infinite length.

Filament designates a textile engineering term for a virtually endless fibre produced by various processes in the chemical industry as constituent part of filament yarns and tows. Filament yarn formed of two or more filaments is known as multifil yarn, while filament yarn formed of but one filament is called monofil yarn.

Transverse titre of a woven fabric refers to the number of transverse threads (weft threads) per centimetre, multiplied by the thread weight of the transverse threads in dtex. The unit is dtex/cm.

Longitudinal titre refers to the number of longitudinal threads (warp threads) per centimetre, multiplied by the thread weight of the longitudinal threads in dtex. The unit is likewise dtex/cm.

The yarns used, their number and the nature of the weave are finally what determines the basis weight of the woven fabric.

Woven polyester fabrics used as carriers for cable wrap tapes typically have basis weights between 60 and 180 g/m². The abrasion strength of an adhesive tape increases with the basis weight of the woven polyester fabric used.

Being highly abrasion-resistant and at the same time hand-tearable is difficult to achieve because these properties make partly contradictory demands of the carrier.

Commercially available cable wrap tapes in high abrasion classes are based on firm carrier materials having correspondingly thick yarns. Yarns from 167 to 330 dtex in linear density are typically employed in both the machine and the cross direction.

However, these are not hand-tearable because of the high thread linear density in the machine direction.

Woven polyester fabric adhesive tapes for cable wrapping under abrasion control are known. They are in use as cable wrap tapes under the tradenames of “Tesa® 51026” or “Coroplast 837X”. They consist of a woven polyester fabric having a basis weight of 125 to 135 g/m² and an 80 to 100 g/m² layer of adhesive. Warp and weft threads have the same yarn weight of about 167 dtex. Owing to the numerous warp threads having high yarn weights, the adhesive tapes are highly abrasion-resistant, thus meeting the requirements of an LV 312 abrasion class D at 10 mm mandrel diameter.

The disadvantage with these known adhesive tapes is that they are very stiff in the longitudinal, i.e. processing, direction because of the very many and thick warp threads in the woven fabric used. Any stiffness in the longitudinal direction is disadvantageous for the use of the adhesive tape as a cable wrap tape because the ends of the adhesive tape have a proclivity to stick up after some time. This behaviour is known as flagging.

It is promoted by high stiffness on the part of the adhesive tape in the longitudinal direction and by small diameters on the part of the wrapped item.

Flagging proclivity is reduced by the adhesive tape having a high level of adhesion to its own reverse side following application. A high level of adhesion presupposes inter alia that the adhesive tape has a high level of adhesive add-on.

Flagging proclivity may decrease on using a softer weave for the woven fabric, for example a twill weave, owing to the decreased level of flexural stiffness.

A woven polyester fabric adhesive tape is known from EP 1 074 595 B1 (and/or priority-giver FR 99 10029 A) which is hand tearable. There is no mention of the adhesive tape having any abrasion resistance or abrasion class.

Longitudinal and transverse titres are reported as not more than 2500 dtex/cm and not more than 4500 dtex/cm, respectively. This would amount to a basis weight for the woven fabric of not more than about 70 g/m². Abrasion class D at 10 mm is unattainable with such a low basis weight.

DE 20 2007 006 816 U also describes a hand-tearable woven fabric adhesive tape consisting of a woven polyester fabric and a layer of adhesive. One woven fabric is exemplified with a longitudinal titre of 2613 dtex/cm and a transverse titre of 5200 dtex/cm.

The abrasion class is reported as Cat 10 mm. This is plausible, since arithmetically the basis weight of the woven fabric must be about 78 g/m², so abrasion class D is unattainable.

EP 2 298 845 A1 discloses an adhesive tape consisting of a layer of adhesive on at least one side of a carrier, wherein the carrier is a woven fabric, preferably a woven polyester fabric.

It is an essential integer of the invention that the quotient formed by dividing the linear density of the longitudinal threads per unit width of the fabric into the linear density of the transverse threads per unit length of the fabric is between 2.2 and 6, preferably 2.8 and 4, and the carrier has a basis weight of not less than 110 g/m².

EP 2 441 813 A1 describes an abrasion-resistant adhesive tape having at least one stripe-shaped carrier supporting, on one side at least, an applied layer of pressure-sensitive adhesive. A liner covers all or part of the adhesive layer. It is stated to be an essential integer of the invention that the carrier is formed by a satin-woven fabric. The satin-woven fabric is further characterized by a repeat number greater than 2 and by a step number not less than 1.

The problem addressed by the invention is that of achieving a marked improvement over the prior art and of providing a tape which enables individual lines to be bandaged into cable assemblies offering high protection against mechanical damage from scuffing and rubbing on sharp edges, burrs or weld spots and which also is hand tearable.

The problem is solved by a tape as more particularly characterized in the main claim. Advantageous embodiments of the invention are described in the dependent claims. The inventive concept further encompasses the use of the tape according to the invention and also a cable harness jacketed with the tape.

The invention accordingly provides an adhesive tape consisting of an adhesive layer on at least one side of a carrier, wherein the carrier is a woven fabric, preferably a woven polyester fabric.

It is an essential integer of the invention that the woven fabric has the following construction:
the thread count in the warp is 34 to 54/cm
the thread count in the weft is 15 to 30/cm
the warp threads have a yarn weight between 38 and 55 dtex
the weft threads have a yarn weight between 500 and 750 dtex.

It surprisingly transpires that using woven fabric carriers where the weft thread has a very high weight whilst the warp thread is comparatively lightweight does meet the requirements of high abrasion resistance while surprisingly the adhesive tape is also hand tearable. The abrasion resistance achieved is abrasion class D as measured on a 10 mm mandrel to the LV 312 standard and also abrasion class D as measured on a 5 mm diameter mandrel to LV 312.

The warp threads preferably have a yarn weight of 40 to 50 dtex, more preferably 42 to 48. The weft threads further preferably have a yarn weight of 600 to 700 dtex, more preferably 660 dtex.

In a further advantageous embodiment of the invention the thread count in the warp is 40 to 50/cm, preferably 46/cm.

In a further advantageous embodiment of the invention the thread count in the weft is 17 to 23/cm, preferably 20/cm.

In a further advantageous embodiment of the invention the transverse threads have a transverse titre above 12 000. The transverse titre is preferably between 13 000 and 18 000, further preferably between 13 500 and 15 000.

The yarns used for the warp and weft threads are preferably polyester yarns, polyamide yarns, polyolefin yarns, viscose yarns and/or mixture yarns comprising the recited materials. Mixture yarns are to be understood for the purposes of the invention as meaning that the warp threads utilize yarns of a different material from the weft threads, while all the warp threads on the one hand and the weft threads on the other consist of the same material, but also embodiments where the yarns for the warp and/or weft threads do themselves consist of different materials.

Yarns of polyester are particularly preferable for the warp and weft threads.

The threads may consist of spun yarns or filament yarns (continuous yarns). Filament yarn is typically used. It consists of a fixed number of individual filaments and may be in textured or flat and point-bonded or unbonded form. The woven fabrics may have been subsequently dyed or consist of spun-dyed yarns.

The thickness of the woven fabric is further preferably not more than 300 μm, more preferably 180 to 280 μm and most preferably 220 to 265 μm.

“Thickness” is to be understood for the purposes of the invention as meaning the extension of the particular layer/phase along the z-ordinate of an imaginary coordinate system where the x-y plane is formed by the plane defined by the machine direction and the cross direction thereto.

In a further advantageous embodiment of the invention, the carrier has a basis weight of up to 200 g/m², preferably 120 to 180 g/m², more preferably 165 g/m².

The adhesive coatweight, based on the area of the adhesive tape, is preferably between 40 and 160 g/m², more preferably between 50 and 100 g/m² and yet more preferably between 60 and 90 g/m².

In a preferred embodiment of the invention, the adhesive tape has an ultimate tensile strength, as measured to DIN EN 14410, of less than 100 N/cm, preferably between 50 to 80 N/cm.

To convert the carrier into an adhesive tape, any known system of adhesive can be employed. In addition to adhesives based on natural or synthetic rubber, especially silicone adhesives and also polyacrylate adhesives are usable.

The adhesive is preferably a pressure-sensitive adhesive, i.e. a viscoelastic material which remains permanently tacky and tackable at room temperature in the dry state. Adherence is immediate to almost all substrates on application under minimal pressure.

An adhesive which will prove particularly suitable is a low molecular weight acrylate hotmelt pressure-sensitive adhesive available from BASF under the name acResin UV. This adhesive, which has a low K value, acquires its use-oriented characteristics in a final radiation-chemically triggered crosslinking reaction.

Very useful adhesives are further described in EP 2 520 627 A1, EP 2 522 705 A1, EP 2 520 628 A1, EP 2 695 926 A1 and EP 2 520 629 A1.

Particular preference is given to a pressure-sensitive adhesive in the form of a dried dispersion of a polymer, wherein the polymer is polymerized from:
(a) 95.0 to 100.0 wt % of n-butyl acrylate and/or 2-ethylhexyl acrylate,
(b) 0.0 to 5.0 wt % of an ethylenically unsaturated monomer having an acid function or an anhydride function.

The polymer preferably consists of 95.0 to 99.5 wt % of n-butyl acrylate and/or 2-ethylhexyl acrylate and 0.5 to 5 wt % of an ethylenically unsaturated monomer having an acid function or an anhydride function, and more preferably consists of 98.0 to 99.0 wt % of n-butyl acrylate and/or 2-ethylhexyl acrylate and 1.0 to 2.0 wt % of an ethylenically unsaturated monomer having an acid function or an anhydride function.

The recited acrylate polymers aside, the pressure-sensitive adhesive may in addition to any residual monomers present have additionally added to it tackifiers and/or additives such as photoprotectant or anti-ageing additives.

In particular, the pressure-sensitive adhesive contains no further polymers such as elastomers; that is, the polymers in the pressure-sensitive adhesive consist only of monomers (a) and (b) in the quantitative ratios stated.

It is preferable for n-butyl acrylate to form monomer (a).

Monomer (b) may advantageously be, for example, acrylic acid, methacrylic acid, itaconic acid, maleic acid, fumaric acid and/or maleic anhydride.

Preference is given to (meth)acrylic acid of formula I,

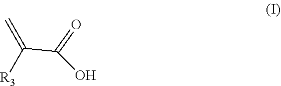

where R³ is ═H or CH₃, while a mixture of acrylic acid or methacrylic acid is optionally used with preference. Acrylic acid is particularly preferable.

In a particularly preferred version, the polymer has the following composition:
(a) 95.0 to 100.0 wt %, preferably 95.0 to 99.5 wt %, more preferably 98.0 to 99.0 wt % of n-butyl acrylate, and
(b) 0.0 to 5.0 wt %, preferably 0.5 to 5.0 wt %, more preferably 1.0 to 2.0 wt % of acrylic acid.

The polymer dispersion is prepared by an emulsion polymerization of the components referred to. Descriptions of this method are found for example in “Emulsion Polymerization and Emulsion Polymers” by Peter A. Lovell and Mohamed S. El-Aasser—Wiley-VCH 1997—ISBN 0-471-96746-7 or in EP 1 378 527 B1.

The possibility with a polymerization is that not all monomers are converted into polymers. It is obvious in this connection that the residual monomer content should be as small as possible.

Preference is given to providing adhesives comprising the polymer dispersion having a residual monomer content of not more than 1 wt %, especially not more than 0.5 wt % (based on the mass of the dried polymer dispersion).

A “tackifying resin” is to be understood in line with the common general understanding among those skilled in the art as being an oligomeric or polymeric resin that enhances the autoadhesion (i.e. the tack, the self-tackiness) of the pressure-sensitive adhesive over the otherwise identical pressure-sensitive adhesive without any tackifying resin.

The use of tackifiers to increase the adherences of pressure-sensitive adhesives is known in principle. This effect also develops on adding to the adhesive up to 15 parts by weight (corresponding to <15 parts by weight), respectively from 5 to 15 parts by weight, of tackifiers (based on the mass of the dried polymer dispersion). The amount of tackifiers added (based on the mass of the dried polymer dispersion) is preferably from 5 to 12 and more preferably from 6 to 10 parts by weight.

Useful tackifiers, or tackifying resins, include in principle any known class of chemical entity. Tackifiers include, for example, hydrocarbon resins (for example polymers based on unsaturated C₅ or C₉ monomers), terpenephenolic resins, polyterpene resins based on raw materials such as for example α- or β-pinene, aromatic resins such as coumarone-indene resins or resins based on styrene or α-methylstyrene such as rosin and its descendent products, for example disproportionated, dimerized or esterified rosin, for example reaction products with glycol, glycerol or pentaerythritol, to name but a few. Preference is given to resins without easily oxidizable double bonds such as terpenephenolic resins, aromatic resins and more preferably resins produced by hydrogenation, for example hydrogenated aromatic resins, hydrogenated polycyclopentadiene resins, hydrogenated rosin derivatives or hydrogenated polyterpene resins.

Resins based on terpenephenols and rosin esters are preferable. Tackifying resins having a softening point above 80° C. as per ASTM E28-99 (2009) are likewise preferable. Resins based on terpenephenols and rosin esters having a softening point above 90° C. as per ASTM E28-99 (2009) are particularly preferable. The resins are conveniently used in dispersion form. In that form they are readily miscible with the polymer dispersion into a finely divided state.

The version where no tackifying resins whatsoever are added to the pressure-sensitive adhesive is particularly preferable.

In an unforeseeable surprise to a person skilled in the art, the absence of tackifying resins from the adhesive tape does not—as a person skilled in the art would have expected—lead to insufficient adherence. In a further surprise, the flagging behaviour is not worse.

The following substances in particular are not added to the pressure-sensitive adhesive:
hydrocarbon resins (for example polymers based on unsaturated C₅ or C₉ monomers)
terpenephenolic resins
polyterpene resins based on raw materials such as for example α- or β-pinene
aromatic resins such as coumarone-indene resins or resins based on styrene or α-methylstyrene such as rosin and its descendent products, for example disproportionated, dimerized or esterified rosin, for example reaction products with glycol, glycerol or pentaerythritol.

It is likewise preferable for the adhesive coating to consist of an adhesive based on synthetic rubber, namely particularly an adhesive comprising at least one vinylaromatic block copolymer and at least one tackifying resin. Typical usage concentrations for the block copolymer range from 30 wt % to 70 wt %, especially from 35 wt % to 55 wt %.

By way of further polymers, those based on purely hydrocarbons such as for example unsaturated polydienes such as natural or synthetically produced polyisoprene or polybutadiene, chemically essentially saturated elastomers such as for example saturated ethylene-propylene copolymers, α-olefin copolymers, polyisobutylene, butyl rubber, ethylene-propylene rubber and also chemically functionalized hydrocarbons such as for example halogen-containing, acrylate-containing or vinyl ether-containing polyolefins may be present, which may replace up to half of the vinylaromatic block copolymers.

Useful tackifiers include tackifying resins that are compatible with the elastomer block of styrene block copolymers.

Useful additives further include, typically, photoprotectant additives such as for example UV absorbers, sterically hindered amines, antiozonants, metal deactivators, processing aids, endblock-reinforcing resins.

Plasticizing agents such as for example liquid resins, plasticizer oils or low molecular weight liquid polymers such as for example low molecular weight polyisobutylenes having molar masses <1500 g/mol (number average) or liquid EPDM grades are typically used.

Fillers such as for example silica, glass (ground or in the form of spheres), aluminas, zinc oxides, calcium carbonates, titanium dioxides, carbon blacks, to name but a few, similarly dyes and colour pigments and also optical brighteners may likewise be used.

Primary and secondary antioxidants are typically added to pressure-sensitive adhesives in order to improve the ageing resistance thereof. Primary antioxidants react with free oxy and peroxy radicals, which may form in the presence of oxygen, reacting with these to form less reactive compounds. Secondary antioxidants for example reduce hydroperoxides to alcohols. There is known to be a synergistic effect between primary and secondary anti-ageing additives, so the protective effect of a mixture is frequently greater than the sum of the two individual effects.

Low flammability desired for the adhesive tape described is attainable by adding flame retardants to the carrier and/or the adhesive. These flame retardants may be organobromine compounds, if necessary together with synergists such as antimony trioxide, although with a view to the adhesive tape being free from halogen, it is red phosphorus, organophosphorus, mineral or intumescent compounds such as ammonium polyphosphate alone or combined with synergists which are used with preference.

Pressure-sensitive adhesives may be produced and processed from solution, dispersion and also from the melt. Preferred production and processing methods proceed from the melt. Suitable methods of making for the latter case include not only batch processes but also continuous processes.

The adhesive may have been applied partially, for example in the longitudinal direction of the adhesive tape in the form of a stripe having a width less than that of the adhesive tape carrier. Depending on the use scenario, it is also possible for two or more parallel stripes of adhesive to have been coated on the carrier material.

The position of the stripe on the carrier is freely choosable, although a disposition directly at one of the edges of the carrier is preferred.

The adhesive coating on the carrier may be covered by one or more covering stripes extending in the longitudinal direction of the adhesive tape and covering between 20% and 80% of the adhesive coating.

A preferred embodiment of the invention has precisely one stripe covering the adhesive coating.

The position of the stripe on the adhesive coating is freely choosable, although a disposition directly at one of the longitudinal edges of the carrier is preferred. This results in an adhesive stripe which extends in the longitudinal direction of the adhesive tape and terminates at the other longitudinal edge of the carrier.

When the adhesive tape is used for jacketing a cable harness by the adhesive tape being guided in a spiral-shaped movement around the cable harness, the sheathing of the cable harness may be carried out such that the adhesive of the adhesive tape is only bonded to the adhesive tape itself, while the item to be wrapped does not come into contact with any adhesive.

The cable harness thus jacketed has a very high degree of flexibility by virtue of the cables not being fixed by any adhesive. This distinctly enhances its bendability at installation—especially including in narrow passages or acute bends.

When a certain degree of fixing of the adhesive tape on the item is desired, the jacketing may be effected such that the adhesive stripe is bonded partly to the adhesive tape itself and for the other part to the item.

In another advantageous embodiment, the stripe sits centrally on the adhesive coating, resulting in two adhesive stripes extending along the longitudinal edges of the carrier in the longitudinal direction of the adhesive tape.

Where the two adhesive stripes each present along the longitudinal edges of the adhesive tape are advantageous is for the secure and economical application of the adhesive tape in said spiral-shaped movement around the cable harness and to counter the slipping of the resulting protective wrapping, especially when one stripe, usually the narrower of the two stripes, serves as a fixing aid and the second, broader stripe serves as fastener. In this way, the adhesive tape is bonded to and on the cable such that the cable assembly is safe from slipping yet nonetheless flexible.

There are also embodiments wherein there is more than one covering stripe on the adhesive coating. Any reference to merely one stripe is automatically read by a person skilled in the art as suggesting that two or more stripes may perfectly well also be capable of covering the adhesive coating at one and the same time.

The stripe preferably covers altogether between 50% and 80% of the adhesive coating. The degree of coverage is chosen in accordance with the application scenario and with the diameter of the cable assembly.

It is particularly preferable for there to remain one or two adhesive stripes whose combined width comprises 20 to 50% of the width of the carrier.

A particularly advantageous version has two stripes of adhesive each present in the edge region of the carrier and extending in the machine direction. Here the edges of the carrier and the outer edges of the stripes of adhesive are positioned one above the other in a preferably edge-accurate manner.

Based on the width of the carrier in the transverse direction, the sum total of the widths of the stripes of adhesive is at most 50% of the width of the carrier.

The stripes preferably have the same width.

Especially when the adhesive is coated not over the whole area but in, for example, stripe form, the stated percentages relate to the width of the stripes of the covering relative to the width of the carrier; that is, according to the invention, the covering stripe or stripes have a width comprising between 20 and 80% of the width of the carrier.

The adhesives thus obtained can then be applied to the carrier using the commonly/generally known methods. These may be coating methods via a nozzle or a calender for processing from the melt.

Known coating processes from solution involve rods, blades or nozzles, to name but a few. Another possibility is to transfer the adhesive onto the carrier assembly from a non-stick backing cloth or release liner.

The reverse side of the adhesive tape may have a coating of a reverse side lacquer in order to promote the unwind properties of the adhesive tape wound to an Archimedean spiral. This reverse side lacquer may for this purpose be endowed with silicone or fluorosilicone compounds and also with polyvinylstearylcarbamate, polyethyleneiminestearylcarbamide or organofluorine compounds as abherents.

If at all, the reverse side lacquer should be used very sparingly so as not to provoke any flagging on the part of the subsequently bonded adhesive tape.

The general expression “adhesive tape” for the purposes of this invention comprehends any sheetlike constructs such as two-dimensionally extended films or film portions, tapes of extended length and limited width, tape portions and the like, ultimately also diecuts or labels.

The adhesive tape may be produced not only in the form of a roll, i.e. self-wound up in the form of an Archimedean spiral, but also lined on the adhesive side with release materials such as siliconized paper or siliconized film.

A preferred release material is a non-fuzzing material such as a plastic film or a highly sized long-fibred paper.

The adhesive tape is used with preference for jacketing elongate items such as, in particular, cable assemblies, for which the elongate item is axially sheathed by the adhesive tape, or the adhesive tape is led in a helical movement around the elongate item. The resulting shape is that of a helix (also called screw, screw line, cylindrical spiral or coil; a helix is a curve winding at constant pitch around the surface of a cylinder).

The concept of the invention lastly also encompasses an elongate item jacketed with an adhesive tape of the invention. The elongate item is preferably a cable assembly.

Owing to its outstanding suitability, the adhesive tape is useful in a jacket which consists of a covering where the self-adhesively endowed adhesive tape is present in an edge region of the covering at least, said adhesive tape being bonded to the covering such that the adhesive tape extends beyond one of the longitudinal edges of the covering, and this preferably in a narrow edge region as compared with the width of the covering.

A product of this type and also optimized embodiments thereof are disclosed in EP 1 312 097 A1. EP 1 300 452 A2, DE 102 29 527 A1 and WO 2006 108 871 A1 present further developments for which the adhesive tape of the invention is likewise very useful. The adhesive tape of the invention may similarly be used in a process as disclosed in EP 1 367 608 A2.

Lastly, WO 2016/023921 A1, WO 2016/045890 A1, EP 2 627 539 A1, EP 1 315 781 A1 and also DE 10 2014 114 794 A1 and DE 103 29 994 A1 describe adhesive tape embodiments of the type also possible for the adhesive tape of the invention.

Adhesive-free carriers are present in some of the abovementioned jackets as well as carriers coated with adhesive or stripes of adhesive. In one preferred version, these adhesive-free carriers consist even then of the carrier described according to the invention. Textile carriers in the builds preferably all consist of the carrier described according to the invention.

The adhesive tape will now be more particularly described with reference to several figures without any intention thereby to cause any kind of restriction.

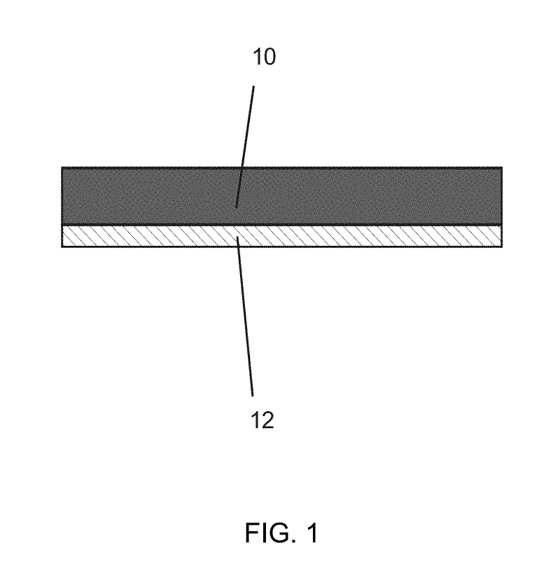

FIG. 1 shows the adhesive tape in lateral section,

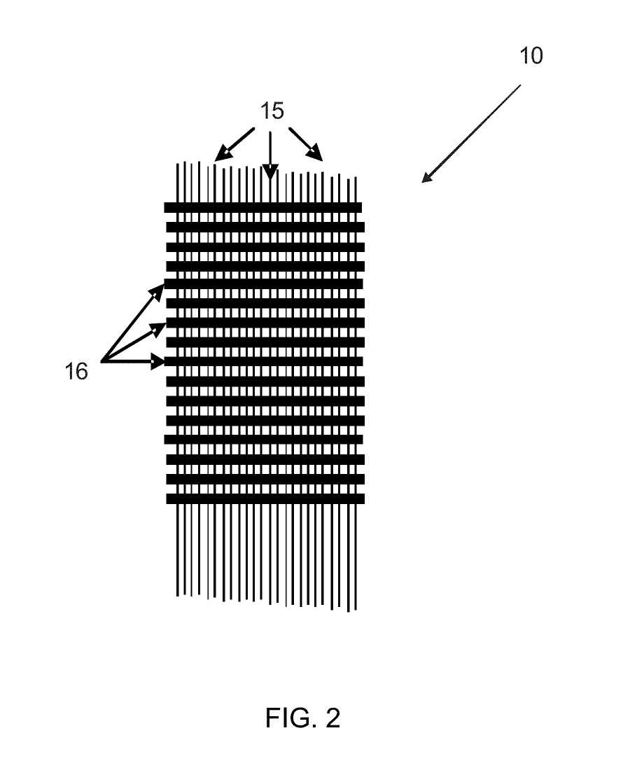

FIG. 2 shows the woven fabric forming the carrier, and

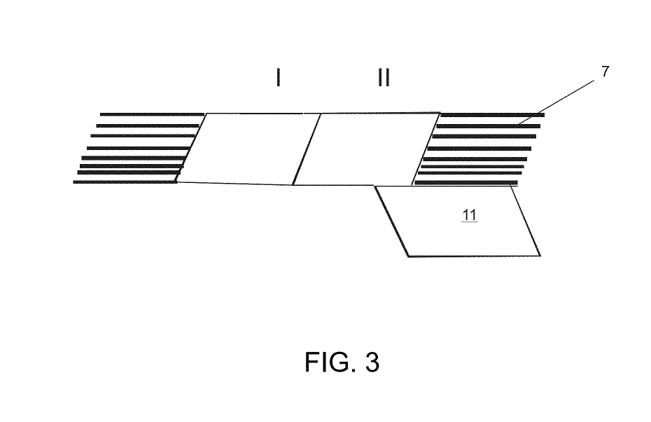

FIG. 3 shows a detail of a cable harness composed of a bundling of individual cables and jacketed with the adhesive tape of the invention,

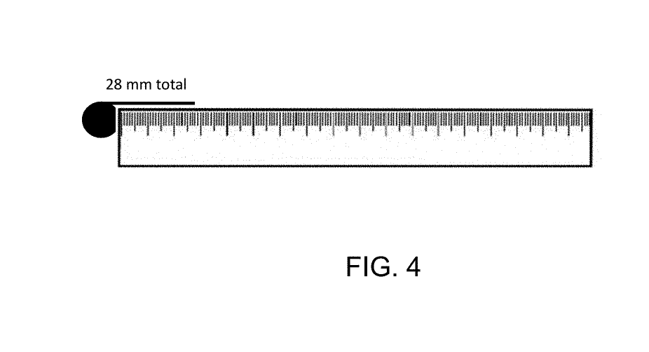

FIG. 4 shows a photograph picturing the tearing behaviour of the adhesive tape of the invention as compared with a known adhesive tape,

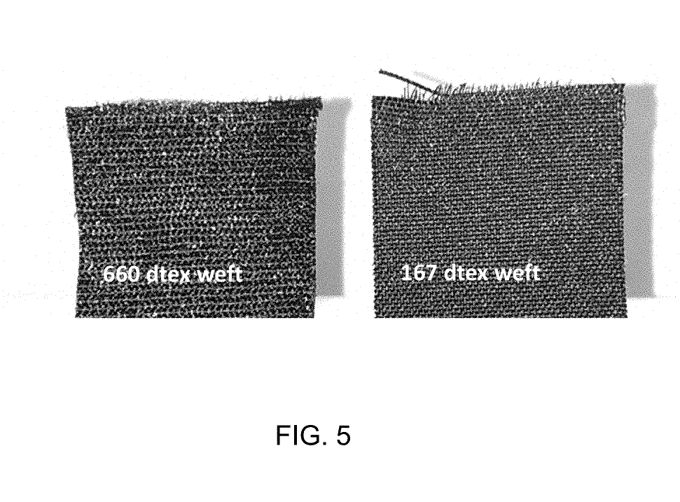

FIG. 5 shows an advantageous application for the adhesive tape.

FIG. 1 shows, in lateral section, the adhesive tape which consists of a woven fabric carrier 10 coated on one side with a layer of a self-adhesive coating 12.

FIG. 2 shows a detailed view of the woven fabric forming the carrier 10. The woven fabric is notable in that the weft threads have a much higher thread weight than the warp threads.

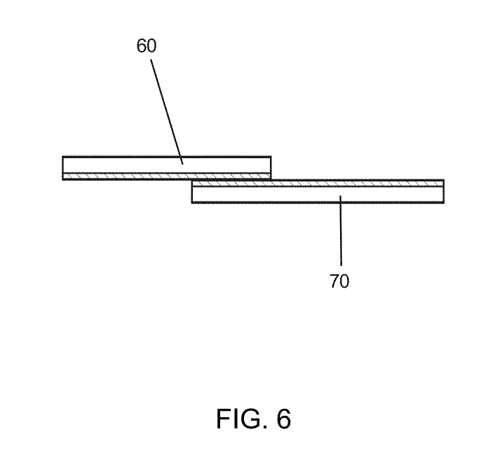

FIG. 3 shows a detail of a cable harness which is composed of a bundling of individual cables 7 and which is jacketed with the adhesive tape 11 of the invention. The adhesive tape is spiraled around the cable harness. The cable harness detail shown shows two windings I and II of the adhesive tape. Further windings would extend towards the left; they are not depicted here. In a further embodiment for a jacket, two adhesive tapes 60 and 70 of the invention are laminated to each other with their adhesive surfaces offset (preferably by 50% each) to form a product as depicted in FIG. 6.

The invention will now be more particularly described with reference to an example and three counterexamples without any intention thereby to limit the invention in any way. Measurements are carried out to the following standards:
Basis weights of woven fabrics and of adhesive coating to DIN EN ISO 2286-1
Yarn weight to DIN 53830 Part 3
Thread count to DIN EN 1049 Part 2
Ultimate tensile strength and ultimate tensile strength extension of the woven fabrics and adhesive tapes in the longitudinal direction to DIN EN 14410 at the maximum of the stress-strain curve (clamped length 100 mm, extension rate 300 mm/min)
Adherence to DIN EN 1939
Thickness of woven fabrics and adhesive tapes to DIN EN 1942
Abrasion resistance to LV312-1
Flexural stiffness was measured to DIN 53362.

### Measurement of Flagging Resistance by SWAT Method

The SWAT test is used to test the flagging behaviour of adhesive tapes after their helical wrapping around a cable.

The test is carried out under standard conditions (23±1° C. and 50±5% rel. humidity) and 40° C. The elevated temperature simulates aggravated requirements during transport.

A 19 mm wide adhesive tape is used for the test. It is wound manually around a cable sheathed with ETFE (ethylene-tetrafluoroethylene) and having a line cross-section of 1 mm², four times (1440°) without additional pressure. Scissors are used to cut the adhesive tape.

A flag on average 5 mm in length is assumed to remain unless the end of the adhesive tape is pressed down.

Altogether seven wraps are produced around the cable.

The flags are measured with a ruler after three days, ten days and 30 days under standard conditions. This is shown by FIG. 4. The absolute flagging value is computed by subtracting 5 mm from the actually measured length of the flag.

The flagging value in FIG. 4 is thus 23 mm (28 mm-5 mm).

The flagging value which is reported as the result is the result of the mean flagging values from the seven wraps. The test at 40° C. is carried out in a similar manner in customary drying cabinets.

The adhesive tape of the invention will now be evaluated at 40° C. in a drying cabinet by the SWAT method reported.

A value of ≤10 mm is deemed to be the lower limit of resistance to flagging.

The grades awarded are 2 to means <5, 1 to means 5 to 10 and 0 to means >10.
(I) Counterexample
(II) Counterexample
(III) Counterexample
(IV) Example in accordance with the invention

TABLE 2
Fabric constructions of various woven PET fabric adhesive tapes

| | | | | | | | (IV) | |
|---|---|---|---|---|---|---|---|---|
| | (I) | | (II) | | (III) | | Invention | |
| Carrier material | woven PET | | woven PET | | woven PET | | woven PET | |
| Basis weight | 125 | g/m² | 85 | g/m² | 113 | g/m² | 160 | g/m² |
| Carrier thickness | 200 | μm | 135 | μm | 185 | μm | 246 | μm |
| Thread count along | 48/cm | | 32/cm | | 40/cm | | 46/cm | |
| (warp) | | | | | | | | |
| Thread weight along | 167 | dtex | 84 | dtex | 167 | dtex | 44 | dtex |
| Longitudinal titre | 8016 | dtex/cm | 2688 | dtex/cm | 6680 | dtex/cm | 2024 | dtex/cm |
| Thread count across | 23/cm | | 30/cm | | 20/cm | | 20/cm | |
| (weft) | | | | | | | | |
| Thread weight across | 167 | dtex | 167 | dtex | 167 | dtex | 660 | dtex |
| Transverse titre | 3840 | dtex/cm | 5010 | dtex/cm | 3340 | dtex/cm | 13200 | dtex/cm |
| Ratio of | 0.48 | | 1.8 | | 0.50 | | 6.5 | |
| transverse/longitudinal | | | | | | | | |
| titres | | | | | | | | |
| Ultimate tensile | 260 | N/cm | 79 | N/cm | 225 | N/cm | 65 | N/cm |
| strength in longitudinal | | | | | | | | |
| direction | | | | | | | | |

TABLE 3
Adhesive tape properties of various woven PET fabric adhesive tapes

| | | | | | | | (IV) | |
|---|---|---|---|---|---|---|---|---|
| | (I) | | (II) | | (III) | | Invention | |
| Type of adhesive | acrylate | | acrylate | | acrylate | | acrylate | |
| Adhesive add-on | 105 | g/m² | 105 | g/m² | 105 | g/m² | 105 | g/m² |
| Total thickness | 271 | μm | 214 | μm | 250 | μm | 295 | μm |
| Adhesion to steel | 5.0 to 7.0 | N/cm | 5.5 to 7.5 | N/cm | 5.0 to 7.0 | N/cm | 5.0 to 7.0 | N/cm |
| Adhesion to | 5.5 to 8.5 | N/cm | 5.5 to 8.5 | N/cm | 5.5 to 8.5 | N/cm | 5.5 to 8.5 | N/cm |
| backing | | | | | | | | |
| Abrasion | class D | | class C | | class C | | class D | |
| resistance | | | | | | | | |
| 10 mm mandrel | | | | | | | | |
| mean | | | | | | | | |
| Abrasion | class D | | class B | | class C | | class D | |
| resistance | | | | | | | | |
| 5 mm mandrel | | | | | | | | |
| mean | | | | | | | | |
| Flagging after | 1-4 | mm | 0 to 3 | mm | 1 to 5 | mm | 0 | mm |
| 7 days | | | | | | | | |

| | | | | |
|---|---|---|---|---|
| Hand tearability | 0/5 | 1/5 | 0/5 | 5/5 |

Hand tearability was evaluated by the woven PET fabrics from Table 2 each being coated with 105 g/m² dry weight of adhesive and slit into 20 mm wide stripes. Five different people subsequently tried to tear each sample in the transverse direction (at right angles to the machine direction) and accordingly judged it to be “hand tearable” or “not hand tearable”. Accordingly, the samples rated five times to be not hand tearable received the entry 0/5. Conversely, the sample which all the test persons were able to tear received the entry 5/5.

Example (IV) demonstrates the advantages of the invention: high abrasion resistance of the adhesive tape coupled with good hand tearability. These two advantages are combinable when the ratio of transverse titre to longitudinal titre is within the limits of the invention and the transverse threads have a transverse titre above 12 000.

FIG. 5 shows a photograph which pictures the tearing behaviour of the adhesive tape according to the invention as compared with a known adhesive tape.

The known adhesive tape consists of a woven fabric carrier having customary weft threads having a thread weight of 167 dtex, whereas the adhesive tape of the invention comprises a woven fabric carrier that has weft threads having a thread weight of 660 dtex.

Surprisingly, given the thick weft threads, filaments are not found to fray on tearing.

1. Adhesive tape consisting of an adhesive layer on at least one side of a carrier, wherein the carrier is a woven fabric,
wherein
the fabric has the following construction:
the thread count in the warp is 34 to 54/cm
the thread count in the weft is 15 to 30/cm
the warp threads have a yarn weight between 38 and 55 dtex
the weft threads have a yarn weight between 500 and 750 dtex.

2. Adhesive tape according to claim 1,
wherein
the thickness of the carrier, as measured to DIN EN 1942, is not more than 300 μm.

3. Adhesive tape according to claim 1,
wherein
the warp threads have a yarn weight of 40 to 50 dtex.

4. Adhesive tape according to claim 1,
wherein
the thread count in the warp is 40 to 50/cm.

5. Adhesive tape according to claim 1,
wherein
the weft threads have a yarn weight of 600 to 700 dtex.

6. Adhesive tape according to claim 1,
wherein
the thread count in the weft is 17 to 23/cm.

7. Adhesive tape according to claim 1,
wherein
the transverse threads have a transverse titre above 12 000.

8. Adhesive tape according to claim 1,
wherein
the carrier has a basis weight of up to 200 g/m².

9. Adhesive tape according to claim 1,
wherein
the carrier is a material selected from the group consisting of woven polyester fabric, a woven polyamide fabric, a woven polyolefin fabric, a woven viscose fabric, and a woven mixture fabric comprising the recited materials.

10. Adhesive tape according to claim 1,
wherein
the adhesive tape has an ultimate tensile strength, as measured to DIN EN 14410, of less than 100 N/cm.

11. Adhesive tape according to claim 1,
wherein
the abrasion resistance of the adhesive tape, as measured on a 10 mm diameter mandrel to LV 312, meets at least abrasion class D, and/or
the abrasion resistance of the adhesive tape, as measured on a 5 mm diameter mandrel to LV 312, meets at least abrasion class D.

12. Adhesive tape according to claim 1,
wherein
the adhesive coatweight, based on the area of the adhesive tape, is between 40 and 160 g/m².

13. Adhesive tape according to claim 1,
wherein
the adhesive coating is a self-adhesive coating.

14. A method for jacketing an elongate item, said method comprising helically leading an adhesive tape according to claim 1 around the elongate item.

15. A method for jacketing an elongate item, said method comprising sheathing the elongate item in the axial direction by an adhesive tape according to claim 1.
